(19) United States
(12) Patent Application Publication
(10) Pub. No.: US 2007/0235488 A1
(43) Pub. Date: Oct. 11, 2007

(54) Structure of a tray for use in a car trunk

(76) Inventor: Johnny Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/390,096

(22) Filed: Mar. 28, 2006

(51) Int. Cl. B60R 7/00; B60R 9/00

(52) U.S. Cl. 224/539; 224/542

(57) ABSTRACT

A tray for use in a car trunk includes a main body, and several gripping elements; the main body has a circumferential wall, and several connecting protrusions thereon, and it is firmly held in a car trunk with the circumferential wall touching an inner side of the trunk; each of the gripping elements has at least one connecting hole on a lower end thereof; the gripping elements are connected to the main body in a relocatable manner with the connecting protrusions being fitted in the connecting holes, such that said gripping elements are pressed against circumferential sides of objects supported on the main body to hold the objects steady.

### BACKGROUND OF THE INVENTION

1. Field of the invention

The present invention relates to a tray for use in a car trunk, more particularly one, which is used for holding luggage in position.

2. Brief Description of the Prior Art

Trunks of cars have relatively large space, which allow people to carry many things with cars. Referring to FIG. 1, a tray 4 is positioned in a trunk 3 of a car for supporting things; both the bottom of the tray 4 and the trunk floor are flat so that the tray 4 can be steady in the trunk 3. However, things supported on the tray 4 are prone to move around or fall over owing to shaking, sudden braking and turn of the car while the car is moving. Consequently, the things can be scattered, and hit the inner side of the trunk 3 to get damaged.

### SUMMARY OF THE INVENTION

It is a main object of the invention to provide an improvement on a tray for use in a car trunk to overcome the above-mentioned problems. The tray of the present invention includes a main body, and several gripping elements; the main body has a circumferential wall, and several connecting protrusions thereon, and it is firmly held in the trunk with the circumferential wall touching an inner side of the trunk; each of the gripping elements has at least one connecting hole on a lower end thereof. The gripping elements are connected to the main body in a relocatable manner with the connecting protrusions being fitted in the connecting holes, such that said gripping elements are pressed against circumferential sides of objects supported on the main body. Therefore, the objects are gripped by the gripping elements and steady, and won't fall over or slip away from their original position in shaking, sudden braking and turn of the car.

### BRIEF DESCRIPTION OF THE DRAWINGS

The present invention will be better understood by referring to the accompanying drawings, wherein:

FIG. 1 is a perspective view of the currently existing tray,

FIG. 2 is an exploded perspective view of the present invention (1),

FIG. 3 is an exploded perspective view of the present invention (2),

FIG. 4 is a lateral sectional view of the present invention in use (1),

FIG. 5 is a horizontal section of the present invention in use (1),

FIG. 6 is a horizontal section of the present invention in use (2),

FIG. 7 is a lateral sectional view of the present invention in use (2),

FIG. 8 is an exploded perspective view of the second embodiment,

FIG. 9 is a lateral sectional view of the second embodiment in use,

FIG. 10 is a view of the present invention in use (3),

FIG. 11 is an exploded perspective view of the third preferred embodiment, and

FIG. 12 is a lateral sectional view of the third embodiment.

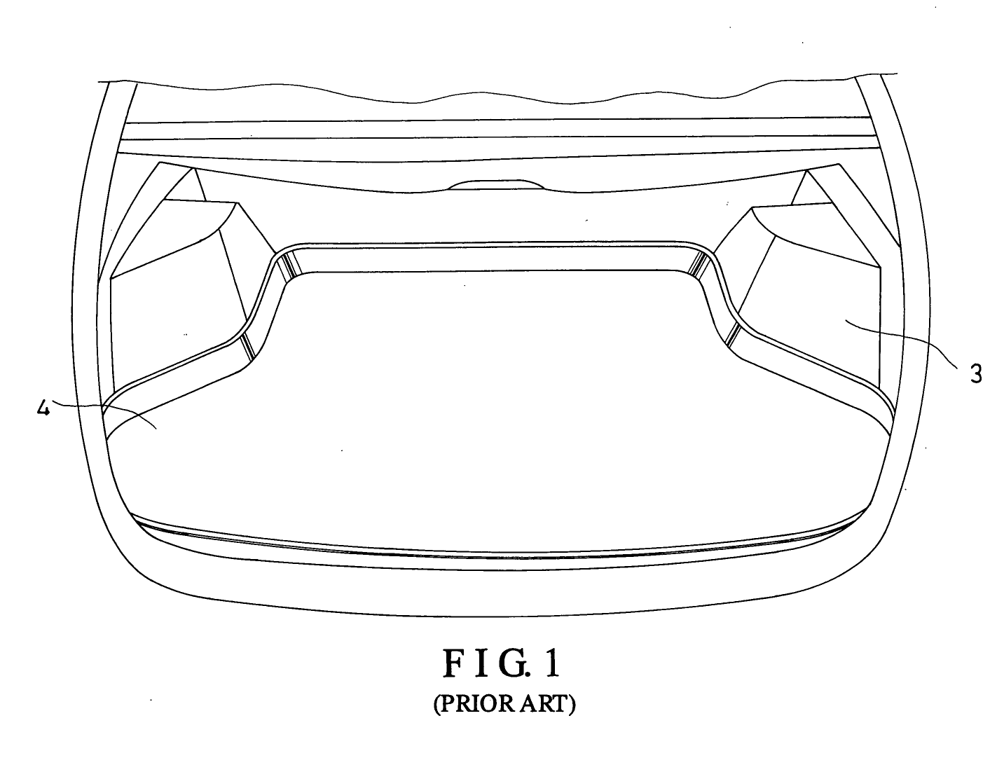

### DETAILED DESCRIPTION OF THE PREFERRED EMBODIMENTS

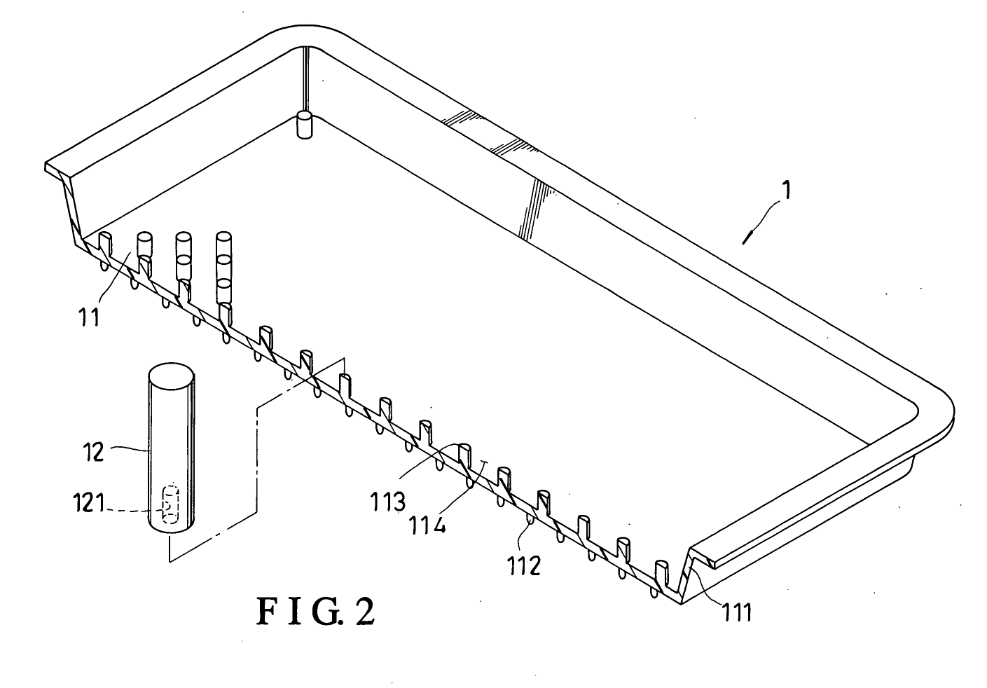

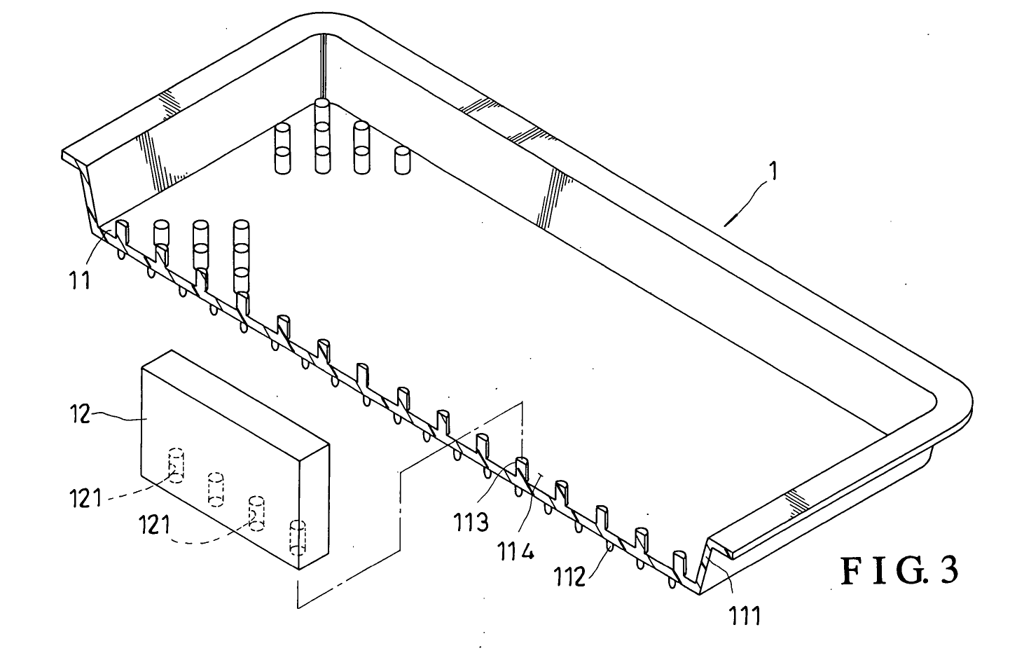

Referring to FIGS. 2 and 3, a first preferred embodiment of a tray 1 for use in a car trunk includes a main body 11, and several gripping elements 12. The main body 11 has a circumferential wall 111, several slip-prevention protrusions 112 on a lower side, and several connecting protrusions 113 spaced apart on an upper side. The circumferential wall 111 has such a shape that it will touch an inner side of a car trunk when the main body 1 is positioned in the car trunk. The gripping elements 12 can be post-shaped or plate-shaped, and each have at least one connecting hole 121 on a lower end such that the gripping elements 12 will be held steady on the main body 11 when the connecting protrusions 113 are inserted in the connecting holes 121 thereof. Intervenient space 114 between the connecting protrusions 113 of the main body 11 has substantially as big as the diameter/thickness of the gripping elements 12; thus, the gripping elements 12 will be held steady by the connecting protrusions 113 when inserted between the connecting protrusions 113.

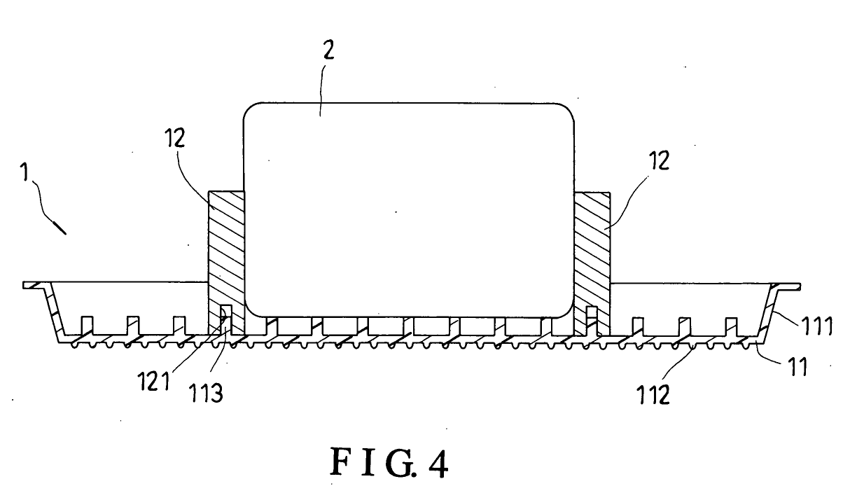

Referring to FIGS. 4 and 5, the main body 11 of the tray 1 is fitted in a car trunk with the circumferential wall 111 closely touching an inner side of the car trunk, and the slip-prevention protrusions 112 helping make the main body 11 steady. And, luggage are supported on the upper side of the main body 11, and several gripping elements 12 are fitted around the connecting protrusions 113 of the main body 11 in such positions that they are pressed against circumferential sides of the luggage; thus, the luggage are steady, gripped by the gripping elements 12. Consequently, the luggage won't slip away from their original position in sudden braking and turn of the car.

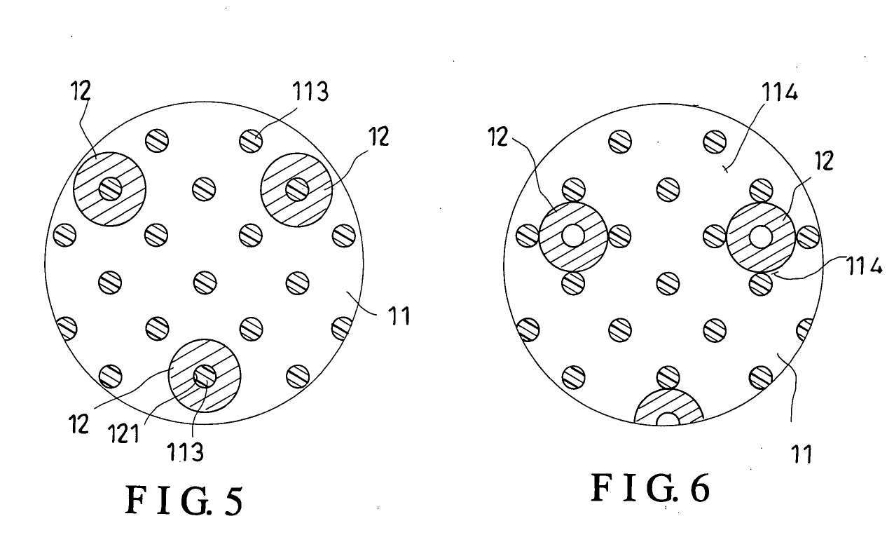

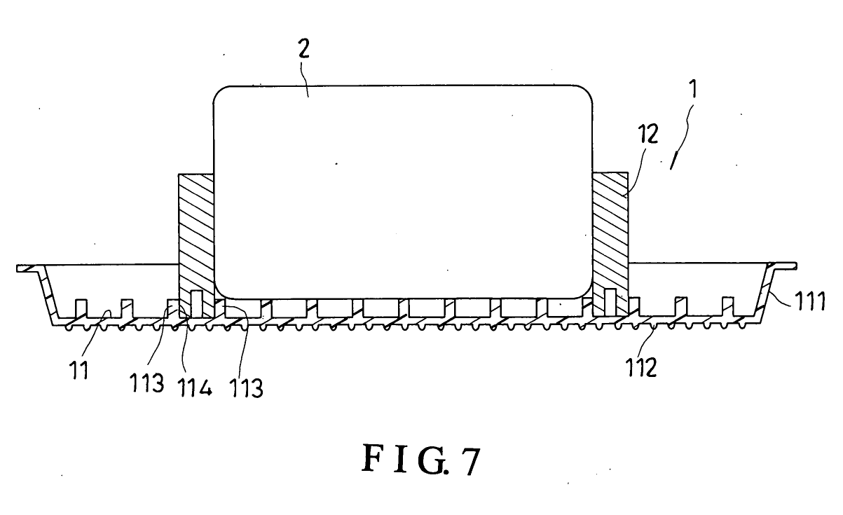

Referring to FIGS. 6 and 7, the gripping elements 12 should be inserted in the intervenient space 114, i.e. between the connecting protrusions 113, instead if a luggage has such a size that a circumferential edge thereof is right above the connecting protrusions 113; thus, the gripping elements 12 still will be pressed against the circumferential side of the luggage, and the luggage is gripped and steady on the tray 1.

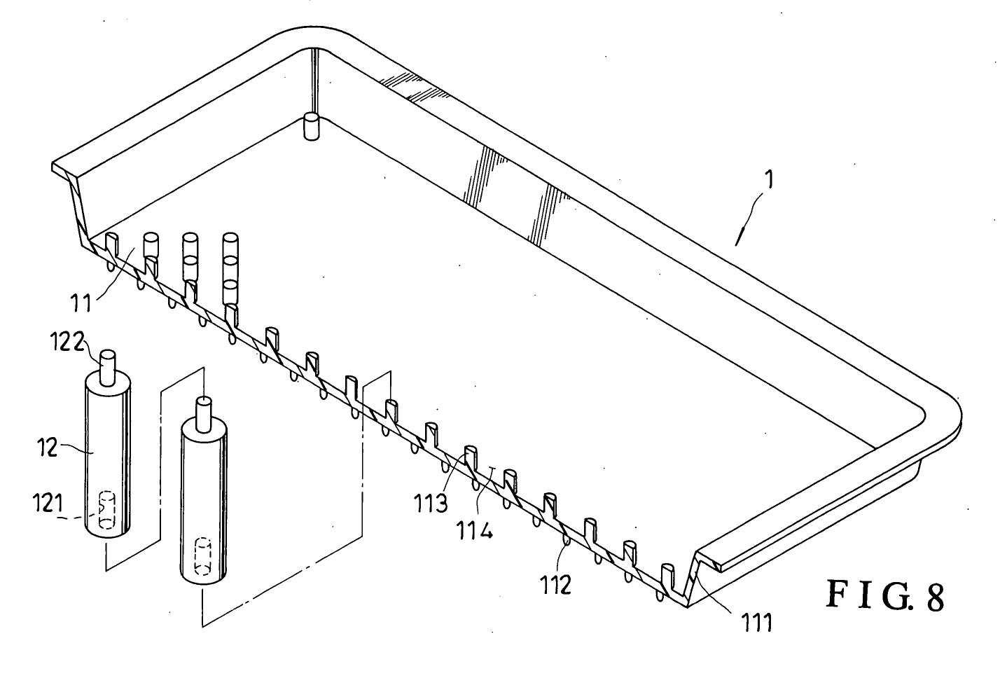

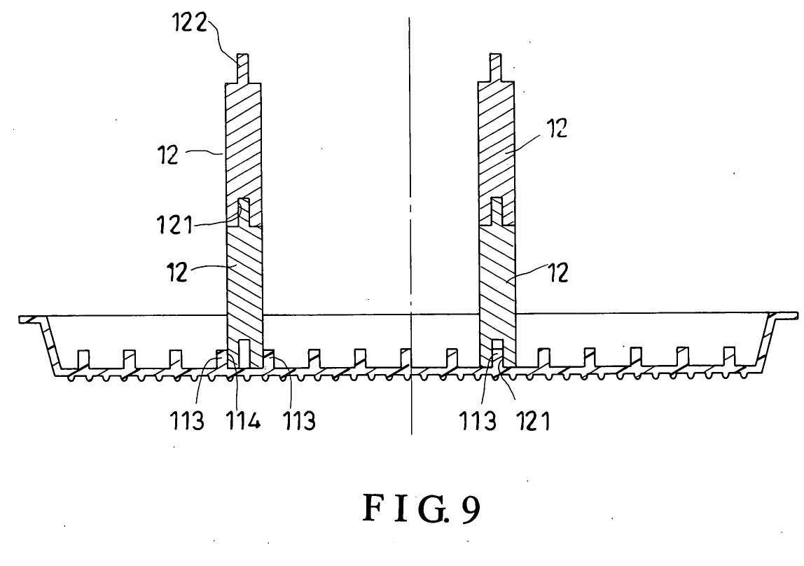

FIGS. 8 and 9 show a second preferred embodiment in the present invention; the gripping elements 12 each further have a post part 122 on an upper end for connection to a connecting hole 121 of another gripping element 12; thus, one gripping element 12 can be joined to a second gripping element 12 to form a longer gripping element by means of inserting the post part 122 into the connecting hole 121 of the second gripping element 12, and the user is allowed to change the length of the gripping elements according to height of things supported on the tray 1.

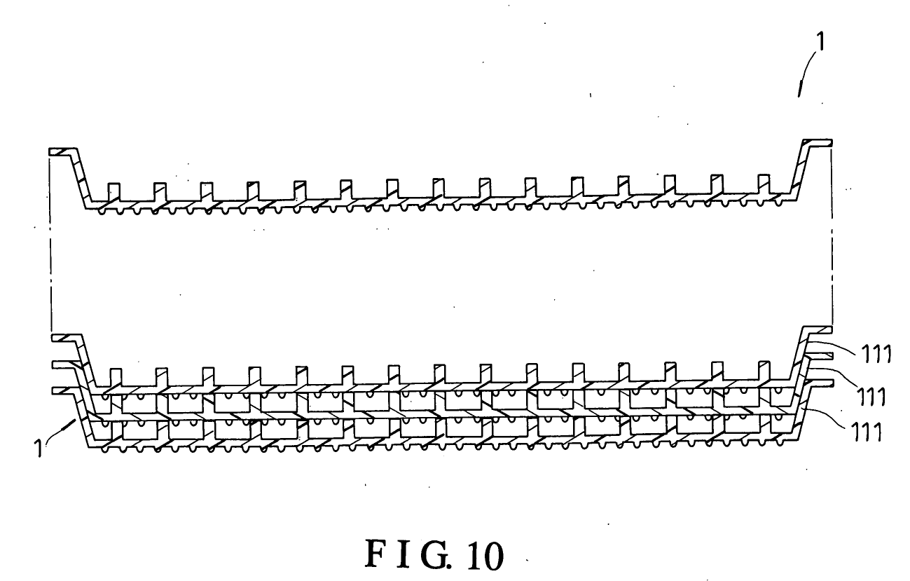

Furthermore, several such trays 1 can be stacked up to occupy less space for easy storage and transportation. When the trays 1 are stacked up, the circumferential walls 111 will help make the pile of trays 1 steady, and prevent the trays 1 from separating from each other owing to shaking in transportation, as shown in FIG. 10.

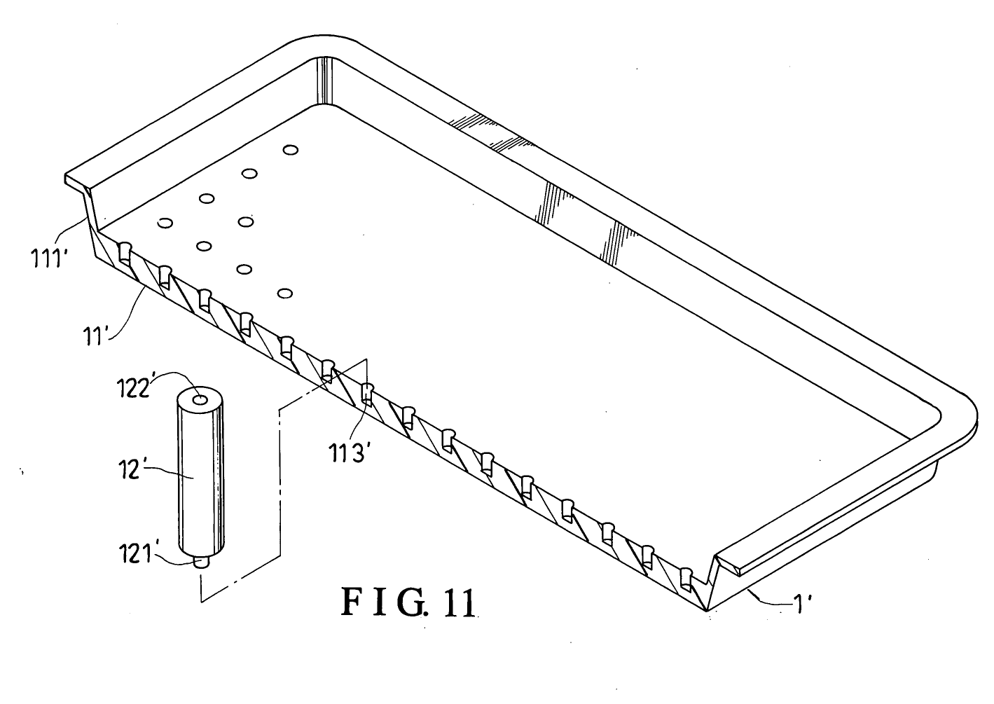

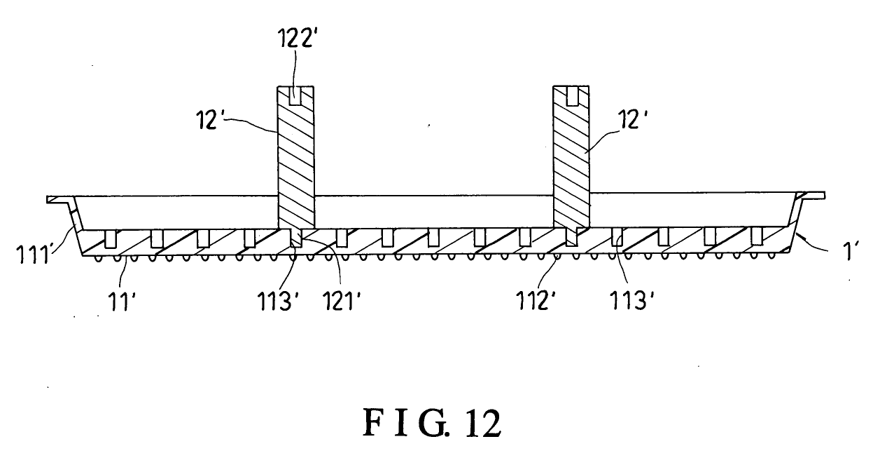

Referring to FIGS. 11 and 12, a third preferred embodiment of a tray 1′ in the present invention includes a main body 11′, and several gripping elements 12′. The main body 11′ has a circumferential wall 111′, several slip-prevention protrusions 112′ on a lower side, and several locating holes 113′ on an upper side thereof. Each of the gripping elements 12′ has a connecting post part 121′ on a lower end, and a hole 122′ on an upper end thereof; thus, the gripping elements 12′ can be fitted on the tray main body 11′ by means of inserting the connecting post parts 121′ into the locating holes 113′. Furthermore, the gripping elements 12′ can be joined together to form a longer gripping element by means of inserting the connecting post parts 121′ into the holes 122′, allowing the user to change the length of the gripping elements according to the height of things supported on the tray 1′.

From the above description, it can be seen that the present invention has the following advantages:

1. The gripping elements are located on the connecting protrusions of the tray main body in a car trunk, and pressed against circumferential sides of things supported on the tray main body. Therefore, the things are gripped by the gripping elements and steady, and won't fall over or slip away from their original position in sudden braking and turn of the car.

2. The gripping elements also can be tightly inserted between the connecting protrusions of the tray main body instead therefore luggage of all sizes can be held steady by means of the gripping elements.

3. Several gripping elements can be joined together to form a longer gripping element for use on a thing with more height, which is supported on the tray main body. In other words, the user is allowed to change the length of the gripping elements according to the height of things supported on the tray.

4. The tray main body is strong and can't be easily folded or deformed owing to its circumferential wall. And, the circumferential wall touches the inner side of a car trunk closely to prevent the tray main body from slipping while the car is moving.

5. After several such tray main bodies are stacked up to occupy less space for easy storage and transportation, the circumferential walls of the tray main bodies will help make the pile steady, and prevent the tray main bodies from separating from each other owing to shaking in transportation.

6. The tray main body is steady and can't slip in a car trunk owing to the slip-prevention protrusions on the lower side thereof.

What is claimed is:

1. A tray for use in a car, comprising
a main body, said main body having a plurality of connecting protrusions thereon; and
a plurality of gripping elements, each of said gripping elements having at least one connecting hole on a lower end thereof; said gripping elements being connected to said main body in a relocatable manner with said connecting protrusions being fitted in said connecting holes, such that said gripping elements are pressed against circumferential sides of objects supported on said main body to hold said objects in position.

2. The tray for use in a car as recited in claim 1, wherein intervenient space between said connecting protrusions of said main body has such a dimension as to allow said gripping elements to fit in.

3. The tray for use in a car as recited in claim 1, wherein each of said gripping elements has a post part on an upper end thereof for fitting in a connecting hole of other one of said gripping elements.

4. The tray for use in a car as recited in claim 1, wherein said main body has a circumferential wall.

5. The tray for use in a car as recited in claim 1, wherein said main body has a plurality of slip-prevention protrusions on a lower side.

6. The tray for use in a car as recited in claim 1, wherein said gripping elements are post-shaped.

7. The tray for use in a car as recited in claim 1, wherein said gripping elements are plate-shaped.

8. A tray for use in a car, comprising
a main body, said main body having a plurality of locating holes thereon; and
a plurality of gripping elements, each of said gripping elements having at least one connecting post part on a lower end thereof; said gripping elements being connected to said main body in a relocatable manner with said connecting post parts being fitted in said locating holes, such that said gripping elements are pressed against circumferential sides of objects supported on said main body to hold said objects in position.

9. The tray for use in a car as recited in claim 8, wherein each of said gripping elements has a hole on an upper end thereof for allowing a connecting post part of other one of said gripping elements to fit in.

10. The tray for use in a car as recited in claim 8, wherein said main body has a plurality of slip-prevention protrusions on a lower side.

11. The tray for use in a car as recited in claim 8, wherein said gripping elements are post-shaped.

12. The tray for use in a car as recited in claim 8, wherein said gripping elements are plate-shaped.
